(19) United States
(12) Patent Application Publication
(10) Pub. No.: US 2015/0049618 A1
(43) Pub. Date: Feb. 19, 2015

(54) SMART WIRELESS ACCESS POINT ANALYZER

(71) Applicant: International Business Machines Corporation, Armonk, NY (US)

(72) Inventors: Barry A. Kritt, Raleigh, NC (US); Thomas S. Mazzeo, Durham, NC (US); Sarbajit K. Rakshit, Kolkata (IN); Eric A. Stegner, Durham, NC (US); Kimberly I. Stegner, Durham, NC (US)

(73) Assignee: International Business Machines Corporation, Armonk, NY (US)

(21) Appl. No.: 14/025,656

(22) Filed: Sep. 12, 2013

Related U.S. Application Data
(63) Continuation of application No. 13/965,981, filed on Aug. 13, 2013.

(51) Int. Cl. H04W 24/08

(52) U.S. Cl. CPC H04W 24/08; H04W 48/16
USPC 370/252; 370/332

(57) ABSTRACT

A method for selecting is disclosed. An apparatus also performs the functions of the method. The method includes identifying one or more wireless networks available for use by an electronic device, determining performance characteristics of at least one of the one or more wireless networks, and determining a wireless network rating for at least one wireless network of the one or more wireless networks. The wireless network rating includes a rating obtained while the electronic device was previously connected to a network. The method includes ranking each of the wireless networks of the one or more wireless networks based on a user profile, the determined performance characteristics, and the wireless network rating for the wireless network.

### CROSS-REFERENCE TO RELATED APPLICATIONS

This application is a continuation of U.S. patent application Ser. No. 13/965,981 entitled “SMART WIRELESS ACCESS POINT ANALYZER” filed on Aug. 13, 2013 for Barry A. Kritt, et al. the entire contents of the above mentioned application is incorporated herein by reference for all purposes.

### BACKGROUND

1. Field

The subject matter disclosed herein relates to network and more particularly relates to selecting an available wireless network.

2. Description of the Related Art

Wireless networks are becoming increasingly popular. An ever increasing number of wireless networks are available in many public and private locations. Wireless networks offer many advantages over wired networks, such as allowing multiple users from one wireless access point, not requiring wires, allowing connection of mobile devices, etc. However, when a user is at a particular location and one or more wireless networks are available, the available wireless networks may be of various qualities, may have various terms and conditions, may charge various rates, may offer various levels of security, etc. Currently many users are limited in that many operating systems merely identify available wireless networks without further identifying important characteristics that users may find useful in selecting a wireless network.

### BRIEF SUMMARY

A method for selecting is disclosed. An apparatus also performs the functions of the method. The method includes identifying one or more wireless networks available for use by an electronic device, determining performance characteristics of at least one of the one or more wireless networks, and determining a wireless network rating for at least one wireless network of the one or more wireless networks. The wireless network rating includes a rating obtained while the electronic device was previously connected to a network. The method includes ranking each of the wireless networks of the one or more wireless networks based on a user profile, the determined performance characteristics, and the wireless network rating for the wireless network.

In one embodiment, the wireless network rating includes a rating available over the internet and the electronic device downloads the wireless network rating while connected to the internet prior to identifying the one or more wireless networks. In another embodiment, the wireless network rating includes input from one or more users of the wireless network associated with the wireless network rating. In another embodiment, the wireless network rating includes a rating on a social media network. In another embodiment, the wireless network rating is downloaded while the electronic device is connected to the wireless network associated with the wireless network rating at a time prior to identifying the one or more wireless networks.

In one embodiment, the method includes selecting a wireless network of the one or more wireless networks with a highest ranking and connecting the electronic device to the selected wireless network. In another embodiment, the method includes presenting the one or more wireless networks to a user of the electronic device along with the ranking of each wireless network, receiving from the user a selection of a wireless network of the one or more wireless networks, and connecting the electronic device to the wireless network selected by the user.

In another embodiment, determining performance of at least one of the one or more wireless networks also includes requesting performance information from at least one of the one or more wireless networks and receiving performance information from the one or more wireless networks where the performance information was requested. In a further embodiment, the performance information includes current bandwidth information for a wireless network. In another further embodiment, the performance information includes firewall information, security information, current signal strength information, maximum signal strength information, wireless network speed, channel, and/or number of users. In another embodiment, determining performance of at least one of the one or more wireless networks also includes measuring bandwidth of a wireless network. In one embodiment, the user profile comprising preferences for ranking available wireless networks. In another embodiment, the user profile is a default user profile or a user modified user profile and ranking of each of the wireless networks includes using the default user profile if a modified user profile is unavailable.

An apparatus for selecting a network includes an identification module that identifies one or more wireless networks available for use by an electronic device, a performance module that determines performance characteristics of at least one of the one or more wireless networks, and a rating module that determines a wireless network rating for at least one wireless network of the one or more wireless networks. The wireless network rating includes a rating obtained while the electronic device was previously connected to a network. The apparatus includes a ranking module that ranks each of the wireless networks of the one or more wireless networks based on a user profile, the determined performance characteristics, and the wireless network rating for the wireless network.

In one embodiment, the apparatus includes an automatic selection module that selects a wireless network of the one or more wireless networks with a highest ranking, and a connection module that connects the electronic device to the selected wireless network. In another embodiment, the apparatus includes a presentation module that presents the one or more wireless networks to a user of the electronic device along with the ranking of each wireless network, a user selection module that receives from the user a selection of a wireless network of the one or more wireless networks, and a connection module that connects the electronic device to the wireless network selected by the user.

In one embodiment, the wireless network rating includes a rating available over the internet and the electronic device downloads the wireless network rating while connected to the internet prior to identifying the one or more wireless networks. In another embodiment, the wireless network rating is downloaded while the electronic device is connected to the wireless network associated with the wireless network rating at a time prior to the identification module identifying the one or more wireless networks. In another embodiment, determining performance of at least one of the one or more wireless networks also includes requesting performance information from at least one of the one or more wireless networks and receiving performance information from the one or more wireless networks where the performance information was requested. In another embodiment, the apparatus includes the electronic device.

Another method for selecting a network includes identifying one or more wireless networks available for use by an electronic device, determining performance characteristics of at least one of the one or more wireless networks, and determining a wireless network rating for at least one wireless network of the one or more wireless networks. The wireless network rating includes a rating obtained while the electronic device was previously connected to a network. The wireless network rating includes a rating available over the internet and the electronic device downloads the wireless network rating while connected to the internet prior to identifying the one or more wireless networks. The method includes ranking each of the wireless networks of the one or more wireless networks based on a user profile, the determined performance characteristics, and the wireless network rating for the wireless network. The method includes presenting the one or more wireless networks to a user of the electronic device along with the ranking of each wireless network, receiving from the user a selection of a wireless network of the one or more wireless networks, and connecting the electronic device to the wireless network selected by the user.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for network selection in accordance with an embodiment of the present invention;

FIG. 2 is a schematic block diagram illustrating one embodiment of an apparatus for network selection in accordance with an embodiment of the present invention;

FIG. 3 is a schematic block diagram illustrating another embodiment of an apparatus for network selection in accordance with an embodiment of the present invention;

FIG. 4 is a schematic flow chart diagram illustrating one embodiment of a method for network selection in accordance with an embodiment of the present invention;

FIG. 5A is a first part of a schematic flow chart diagram illustrating another embodiment of a method for selecting a network in accordance with an embodiment of the present invention; and

FIG. 5B is a second part of the schematic flow chart diagram illustrating another embodiment of a method for selecting a network in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

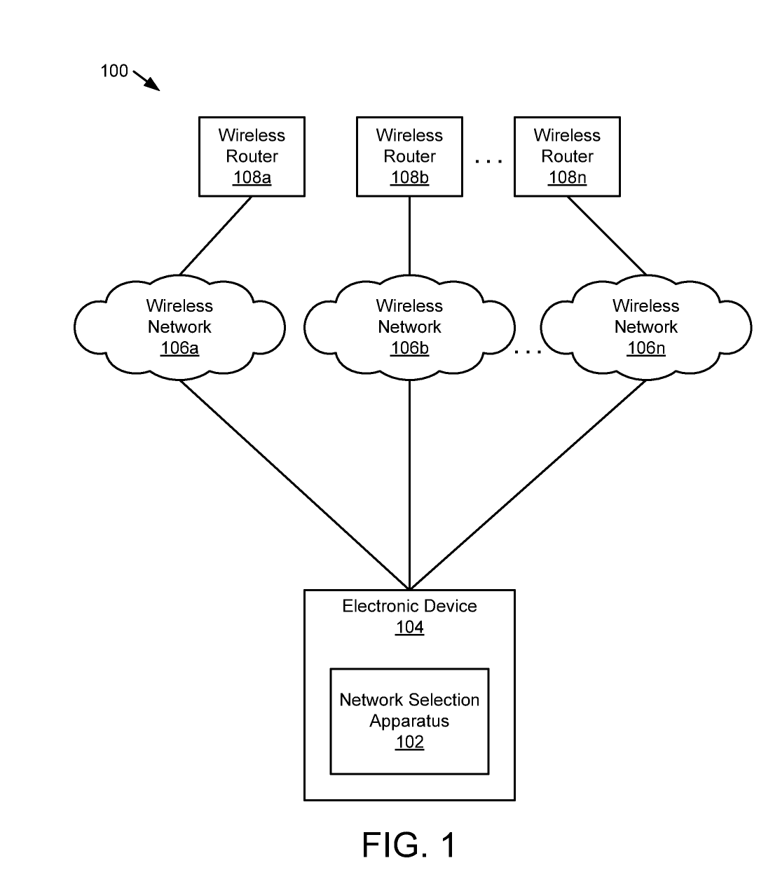

FIG. 1 is a schematic block diagram illustrating one embodiment of a system 100 for network selection in accordance with an embodiment of the present invention. The system 100 includes a network selection apparatus 102, an electronic device 104, wireless networks 106a-n (collectively or generically “106”), and wireless routers 108a-108n (collectively or generically “108”), which are described below.

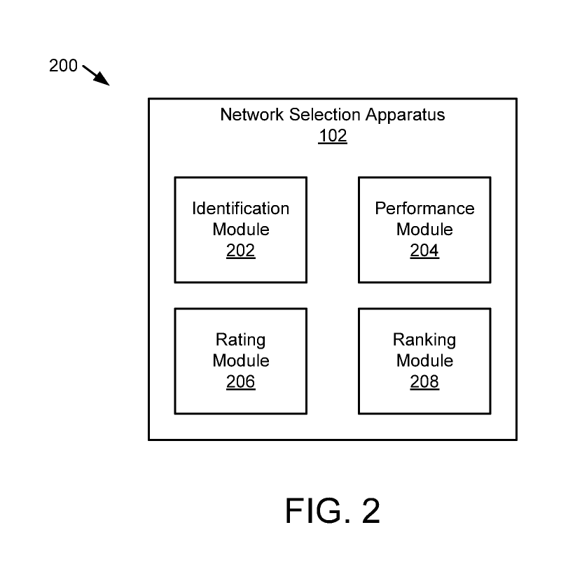

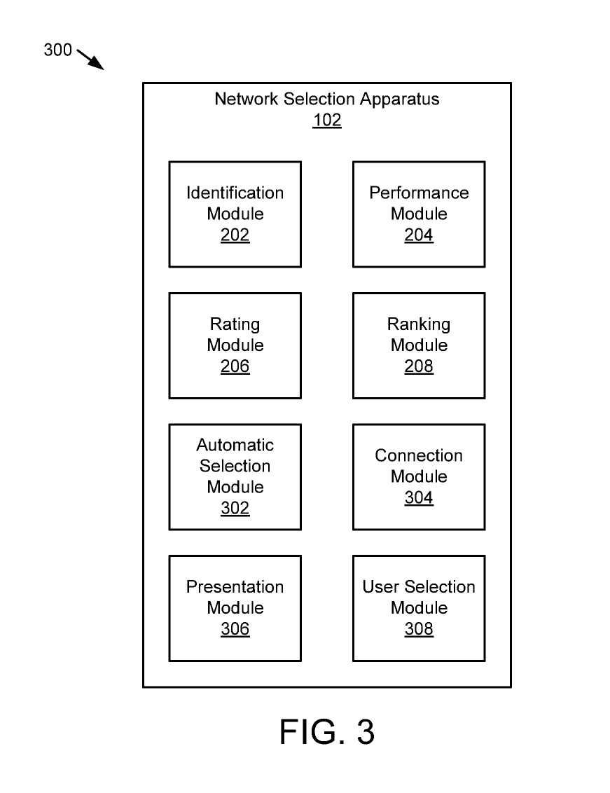

The system 100 includes a network selection apparatus 102 that helps a user identify and select a wireless network 106a-n. The network selection apparatus 102 will be described in more detail with regard to the apparatuses 200, 300 of FIGS. 2 and 3.

The system 100 includes an electronic device 104, and in one embodiment, the network selection apparatus 102 is included in the electronic device 104. In other embodiments, the network selection apparatus 102 includes portions that are located in other devices. In some embodiments, the electronic device 104 may be a mobile electronic device, such as a cellular phone, a smartphone, a tablet computer, a radio, a laptop computer, a Global Positioning System (“GPS”) device, etc. The electronic device 104, in other embodiments, may be a desktop computer, a server, a workstation, an appliance, a computing device in a vehicle, or any other device that communicates wirelessly. In another embodiment, the electronic device 104 may include multiple devices, such as input devices, displays, etc. In one embodiment, the electronic device 104 includes an electronic display capable of displaying wireless network options. In another embodiment, the electronic device 104 includes one or more audio devices capable of audibly communicating with a user various wireless network options. One of skill in the art will recognize other electronic devices 104 capable of wireless communications.

The system 100 includes at least one wireless network 106 transmitted by a wireless router 108. Often spaces, such as public spaces, are in range of one or more wireless networks 106 and provide a user of the electronic device 104 a choice for connection to a computer network. Each wireless router 108 typically connects to other networks and may connect to the Internet. The wireless routers 108 may be connected with cable, such as fiber optic cable, category 5 cable, etc. or may be connected wirelessly to other equipment and networks. The wireless routers 108 may connect to servers, routers, switches, etc. to enable a user to connect to desired webpages, file locations, etc.

In one embodiment, a wireless network 106 and associated wireless router 108 may be a portion of a computer network. For example, a wireless network 106, which may also be called a hotspot or a Wi-Fi hotspot, may be owned or connected to an internet service provider. A wireless network 106 may also be called a wireless local area network (“WLAN”). A wireless network 106 may be publically accessible or privately accessible. In one embodiment, an electronic device 104 may access wireless networks 106 of different types. For example, one available wireless network (e.g. 106a) may be a Wi-Fi hotspot while another available wireless network (e.g. 106b) may be a cellular network.

FIG. 2 is a schematic block diagram illustrating one embodiment of an apparatus 200 for network selection in accordance with an embodiment of the present invention. The apparatus 200 includes one embodiment of the network selection apparatus 102 that includes an identification module 202, a performance module 204, a rating module 206, and a ranking module 208, which are described below.

In one embodiment, the apparatus 200 includes an identification module 202 that identifies one or more wireless networks 106 available for use by the electronic device 104. For example, the identification module 202 may detect wireless network signals. The identification module 202 may use hardware of the electronic device 104, such as a wireless receiver and accompanying electronics and software to detect the wireless network signals. In another embodiment, the identification module 202 may include hardware to detect wireless network signals. The identification module 202, in one embodiment, detects signals and/or coding within the wireless network signals to identify a specific wireless network 106. For example, the identification module 202 may identify an identifier, a network name, a wireless router address, etc. to identify the wireless network 106.

In one embodiment, the identification module 202 identifies a name of the wireless network 106 that is publically known. The publically known name may be used by users of the wireless network 106 to provide rating information on a website associated with the wireless network 106, a blog about the wireless network 106 or about wireless networks in general, a social media website or other location where a user would comment on or rate the wireless network 106.

In one embodiment, the identification module 202 identifies one or more wireless networks 106 that have a signal strength that is strong enough to communicate identification information about the wireless networks 106. In another embodiment, the identification module 202 identifies one or more wireless networks 106 that have a signal strength that is strong enough to establish reliable data communications over the wireless networks 106. One of skill in the art will recognize other criteria for the identification module 202 to identify one or more wireless networks 106 while ignoring other wireless networks 106.

The apparatus 200, in one embodiment, includes a performance module 204 that determines performance characteristics of at least one of the one or more wireless networks 106. In one embodiment, the performance module 204 determines performance characteristics of a wireless network 106 by receiving information from the wireless network 106 without any specific request to the wireless router 108 associated with the wireless network 106. In another embodiment, the performance module 204 determines performance characteristics of a wireless network 106 by transmitting a request to the associated wireless router 108 for performance information. In another embodiment, the performance module 204 determines performance characteristics for a wireless network 106 by receiving information from the wireless network 106 with and without a request for information.

Performance characteristics may include bandwidth information. The bandwidth information of a wireless network 106 may include bandwidth available to the electronic device 104 factoring in a current number of users of the wireless network 106, an available bandwidth of the associated wireless router 108, a number of current users, etc. In one embodiment, the bandwidth information may factor in network traffic beyond the wireless router 108. For example, the bandwidth information may be for the electronic device 104 to a particular gateway or other network location. In another example, the bandwidth information may factor in signal strength data that may affect bandwidth. In another embodiment, the bandwidth information may include a percent utilization of a total available bandwidth, or similar measurement.

In one embodiment, the performance module 204 measures bandwidth of a wireless network 106. For example, the performance module 204 may measure bandwidth by sending and receiving packets of data to determine bandwidth of the wireless network 106. The performance module 204 may also verify bandwidth by comparing bandwidth information provided by the wireless network 106 with a measurement of bandwidth of the wireless network 106. Comparison of reported bandwidth versus measured bandwidth of a wireless network 106 may also be used in a rating of the wireless network 106. One of skill in the art will recognize other ways to characterize bandwidth in a way to be useful for ranking a wireless network 106.

Performance characteristics may also include security information regarding a wireless network 106. For example, the security information may include whether security is available or if the wireless network 106 is open. The security information may include, for example, a security standard used by the wireless network 106 such as Wired Equivalent Privacy (“WEP”), Wi-Fi Protected Access (“WPA”), WPA2, etc. The security information may also include firewall information, such as security through a network beyond the wireless router 108.

In one embodiment, the performance characteristics include performance information gathered while the electronic device 104 was connected to the wireless network 106 previously. For example, the performance module 204 may assess performance while the electronic device 104 is connected to the wireless network 106 and may then store the performance information for use when the wireless network 106 is identified again by the identification module 202. In another embodiment, the performance information may include performance information from other users, such as users currently using the wireless network 106 or users that have used the wireless network 106 previously. For example, the performance information may come from webpages, blogs, etc. that include rating information for the wireless network 106.

In another embodiment, the performance characteristics include information about signal strength and range of the wireless router 108. In one example, the performance module 204 may determine a signal strength of the wireless network 106 at a current location of the electronic device 104. In another embodiment, the performance module 204 may receive or identify a signal strength available at the wireless router 108 of the wireless network 106 and may determine a distance of the electronic device 104 from the wireless router 108, a range of the wireless router 108, etc. In another embodiment, the performance module 204 takes into account movement of the electronic device 104 to determine when the wireless network 106 will be out of range of the wireless network 106. In another example, the performance module 204 may use location information of the wireless router 108 along with location information for the electronic device 104 to determine signal strength information or in conjunction with a determined signal strength to determine coverage and/or signal strength of the wireless network 106. In one embodiment, the performance module 204 uses signal strength information and one or more thresholds to determine wireless network availability. One of skill in the art will recognize other ways to measure and/or calculate signal strength.

In one embodiment, the performance characteristics include terms and conditions of use of a wireless network 106. For example, the terms and conditions might include whether or not the user is charged for using the wireless network 106, how much is charged, data limitations, bandwidth limitations, and other limitations and conditions imposed by an owner of a wireless network 106.

The apparatus 200 includes, in one embodiment, a rating module 206 that determines a wireless network rating for at least one wireless network (e.g. 106a) of the one or more wireless networks 106. The wireless network rating includes a rating obtained while the electronic device 104 was previously connected to a network. For example, the rating module 206 may obtain a rating while the electronic device 104 was previously connected to the wireless network 106a. For instance, the rating module 206 may query the wireless router 108a to obtain rating information. The rating information, for example, may be maintained by a service running the wireless network 106a. In another embodiment, the rating module 206 may obtain rating information about the wireless network 106 while connected to a different network, such as a wired computer network, a different wireless network, etc.

In various embodiments, the rating module 206 obtains rating information from a social media website, a webpage that maintains information about various wireless networks, from an owner of the wireless network 106a, etc. The rating module 206 may use solely rating information gathered from a particular source, may combine rating information from various sources, may use past rating information with current rating information, etc. One of skill in the art will recognize other ways that the rating module 206 may determine a wireless network rating for the wireless network 106a. The rating module 206, in one embodiment, determines a wireless network rating using two or more ratings. For example, the rating module 206 may determine a wireless network rating for a wireless network 106a by averaging two or more ratings. In another example, the rating module 206 may use various parts of two or more ratings to determine a wireless network rating for the wireless network 106a. In another embodiment, the rating module 206 uses rating information from the user of the electronic device 104 to determine a wireless network rating. One of skill in the art will recognize other ways that the rating module 206 can determine a wireless network rating.

The apparatus 200, in one embodiment, includes a ranking module 208 that ranks each of the wireless networks 106a-n of the one or more wireless networks 106 based on a user profile, the determined performance characteristics, and the wireless network rating for the wireless network 106. In one embodiment, the user profile is a default user profile and the ranking module 208 uses criteria and preferences from the default user profile. In another embodiment, the user profile is created by a user and the ranking module 208 uses criteria and preferences from the user profile created by the user. The ranking module 208 may weight various criteria from the performance characteristics and wireless network rating to create a ranking for a wireless network (e.g. 106a).

The ranking module 208 may use information from various sources to rank a wireless network 106a. For example, the ranking module 208 may use signal strength measured by the electronic device 104, information transmitted initially from the wireless network 106a, information returned as a result of a query by the performance module 204, and rating information gathered by the rating module 206. The ranking module 208, in one embodiment, ranks the wireless networks 106a-n so that each has a separate ranking and is ranked relative to each other. In another embodiment, the ranking module 208 ranks the wireless networks 106a-n where some wireless networks 106 may include a same ranking. For example, some may have an “A” ranking, some a “B” ranking, etc. Other ranking schemes may also be used, such as numbers stars, etc.

In another embodiment, the ranking module 208 ranks the wireless networks 106a-n with respect to each other so the wireless networks 106a-n are in an order and also provides a quality ranking, such as an A, B, C, etc. For example, wireless networks 106a-n identified by the identification module 202 in a particular location may all be a lower quality and may all be ranked with a B or C but are ranked with respect to each other and are put in an order from best to worst. In another location, some of the wireless networks 106a-n identified by the identification module 202 may have a higher quality so some have an A and some have a B while the wireless networks 106a-n are again ranked with each other and are put in an order from best to worst.

In one embodiment, the ranking module 208 uses input from a user in ranking the wireless networks 106a-n. For example, the ranking module 208 may allow a user to modify rankings of the wireless networks 106a-n. In another embodiment, the ranking module 208 allows input from wireless network owners in the rankings. For example, a particular wireless network owner may pay to have the owner's wireless network 106a ranked higher than the wireless network 106a might otherwise have been ranked. One of skill in the art will recognize other ways that the ranking module 208 may rank wireless networks 106a-n.

FIG. 3 is a schematic block diagram illustrating another embodiment of an apparatus 300 for network selection in accordance with an embodiment of the present invention. The apparatus 300 includes, in one embodiment, an embodiment of the network selection apparatus 102 that includes an identification module 202, a performance module 204, a rating module 206, and a ranking module 208, which are substantially similar to those described above in relation the apparatus 200 of FIG. 2. The apparatus 300, in various embodiments, may also include an automatic selection module 302, a connection module 304, a presentation module 306 and a user selection module 308, which are described below.

In one embodiment, the apparatus 300 includes an automatic selection module 302 that selects a wireless network (e.g. 106b) of the one or more wireless networks 106a-n with a highest ranking. For example, the automatic selection module 302 may use the ranking from the ranking module 208 to select the wireless network 106b with the highest ranking. In another embodiment, the automatic selection module 302 may use the ranking from the ranking module 208 along with other criteria for selecting the wireless network 106b. For example, the automatic selection module 302 may use one or more thresholds, such as minimum signal strength, a maximum distance from a wireless router 108, etc. along with a ranking from the ranking module 208 to select the wireless network 106b.

The apparatus 300 also includes a connection module 304 that connects the electronic device 104 to the selected wireless network 106b. For example, the automatic selection module 302 and the connection module 304 may work together to connect the electronic device 104 to the wireless network 106b without input from the user after the ranking module 208 ranks the wireless networks 106a-n. In another embodiment, the connection module 304 allows a user to override the automatic selection module 302 to disconnect from the wireless network 106b and to connect to another wireless network (e.g. 106a). In another embodiment, the connection module 304 asks the user for confirmation before connecting. In another embodiment, the connection module 304 notifies the user that a connection to the wireless network 106b has been made.

In one embodiment, the identification module 202, performance module 204, ranking module 208, automatic selection module 302, and connection module 304 work autonomously to identify wireless networks 106 as a user moves with the electronic device 104 or as network conditions change and automatically switches to another wireless network (i.e. 106a to 106b) when another network has a higher ranking, when a connected network has a low signal strength, etc.

In another embodiment, the apparatus 300 includes a presentation module 306 that presents the one or more wireless networks 106a-n to a user of the electronic device 104 along with the ranking of each wireless network 106a-n. The apparatus 300 may also include a user selection module 308 that receives from the user a selection of a wireless network (e.g. 106a) of the one or more wireless networks 106a-n and the connection module 304 then connects the electronic device 104 to the selected wireless network 106a.

The presentation module 306 may present the wireless networks 106a-n in a variety of ways. For example, the presentation module 306 may present the wireless networks 106a-n as a list in a ranking order. In another example, the presentation module 306 presents the wireless networks 106a-n on a map with a ranking by each identified wireless network 106a-n. In another embodiment, the presentation module 306 presents the wireless networks 106a-n in a table. The presentation module 306 may also include other information about the wireless networks 106a-n, such as ratings, performance characteristics, cost information, etc. In one example, the presentation module 306 provides the other information in a list with all of the identified wireless networks 106a-n. In another embodiment, the presentation module 306 provides the other information if a user selects a particular wireless network (e.g. 106a). One of skill in the art will recognize other ways that the presentation module 306 may present identified wireless networks 106a-n along with rankings to a user.

The presentation module 306 or the user selection module 308 may provide a way for the user to select a wireless network (e.g. 106a). For example the presentation module 306 or the user selection module 308 may include a box to check by each listed wireless network 106, may provide a hot link on the wireless network name, etc. In one embodiment, the user selection module 308 may require a confirmation from the user before the connection module 304 connects the electronic device 104 to the wireless network 106a. In another embodiment, the user may include a preference to allow the automatic selection module 302 to automatically select a wireless network 106 or to allow the presentation module 306 to present wireless networks 106 to the user for selection.

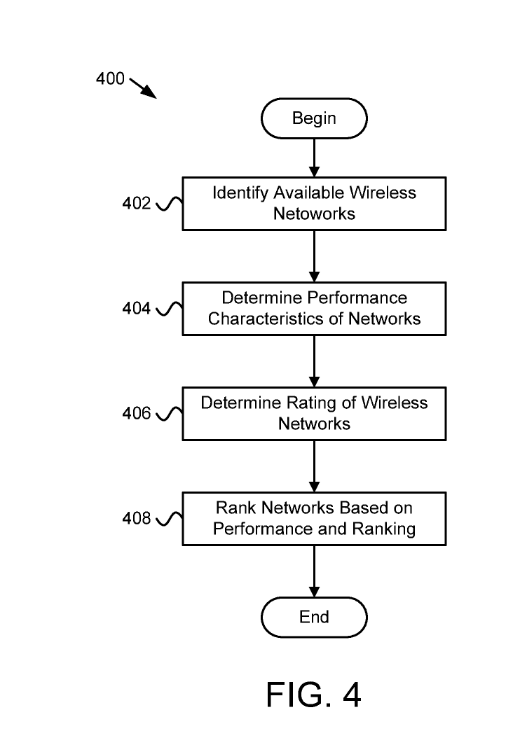

FIG. 4 is a schematic flow chart diagram illustrating one embodiment of a method 400 for network selection in accordance with an embodiment of the present invention. The method 400 begins and identifies 402 one or more wireless networks 106a-n available for use by the electronic device 104. The method 400 may identify 402 wireless networks 106 around a current location of the electronic device 104. The method 400 may update the identified available wireless networks 106 as the electronic device 104 move, as signal strengths change, etc.

The method 400 determines 404 performance characteristics of at least one of the one or more wireless networks 106 and determines 406 a wireless network rating for at least one wireless network (e.g. 106a) of the one or more wireless networks 106. The method 400, in one embodiment, the wireless network rating is a rating obtained while the electronic device 104 was previously connected to a network. The method 400 ranks 408 each of the wireless networks 106 based on a user profile, the determined performance characteristics, and the wireless network rating for the wireless network 106, and the method 400 ends. In various embodiments, the method 400 may use the identification module 202, the performance module 204, the rating module 206, and the ranking module 208.

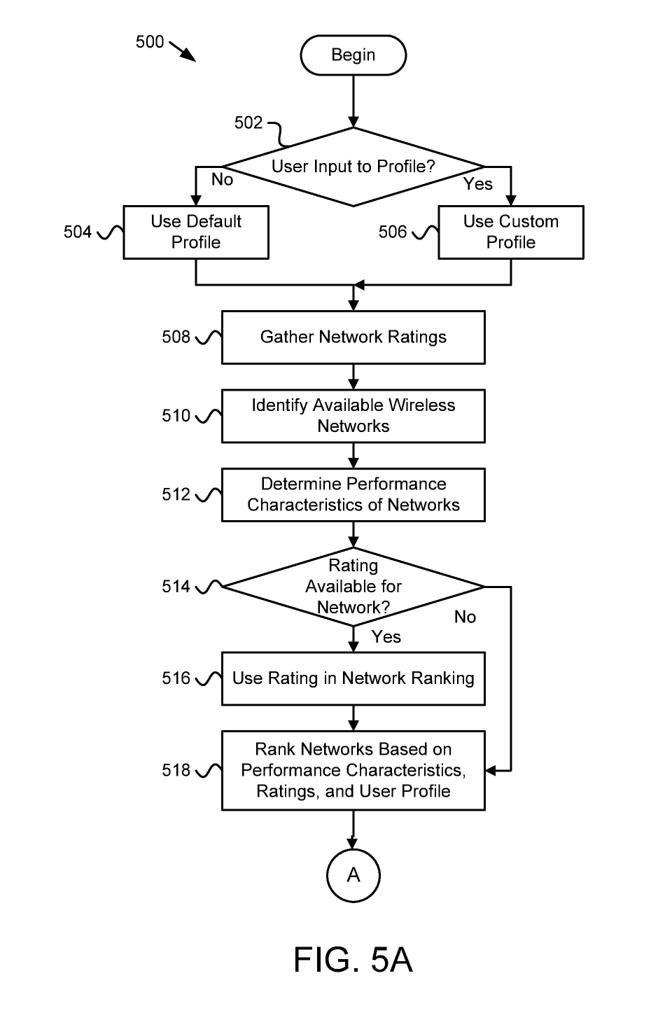

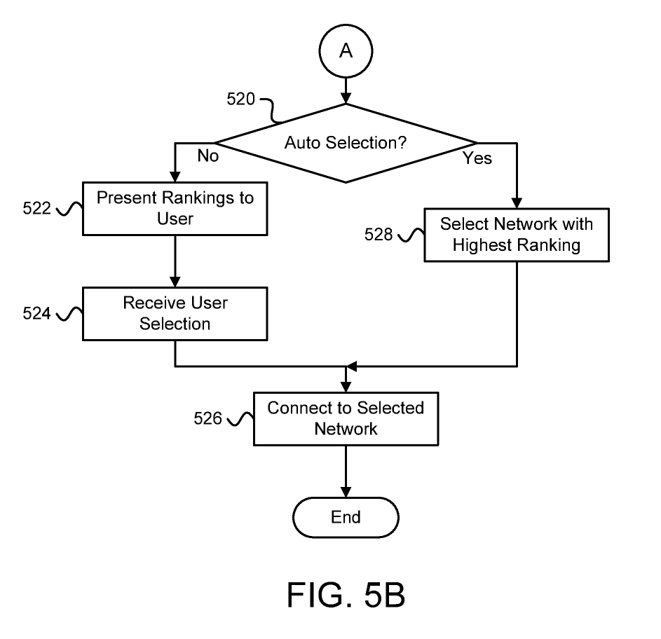

FIGS. 5A and 5B are a first part and a second part of a schematic flow chart diagram illustrating another embodiment of a method 500 for selecting a network in accordance with an embodiment of the present invention. The method 500 begins and determines 502 if there is user input to a user profile. If the method 500 determines 502 that there is no user input, the method 500 uses 504 a default user profile. If the method 500 determines 502 that there is user input, the method 500 uses 506 a custom user profile that has been created or modified by a user. The method 500 gathers 508 wireless network ratings for various wireless networks 106. For example, the method 500 may gather 508 wireless network ratings from the Internet or from a previous use of a wireless network (e.g. 106a).

The method 500 identifies 510 one or more wireless networks 106a-n available to the electronic device 104 and determines 512 performance characteristics of at least one of the one or more wireless networks 106a-n. The method 500 determines 514 if a rating gathered previously is available for an indentified wireless network 106a-n. If the method 500 determines 514 that a rating gathered previously is available for a particular indentified wireless network (e.g. 106a), the method 500 uses 516 the rating while determining wireless network rankings. If the method 500 determines 514 that a rating gathered previously is not available for a particular indentified wireless network (e.g. 106b), the method 500 does not uses a rating while determining wireless network rankings. The method 500 ranks 518 the identified wireless networks 106a-n based on performance characteristics, ratings, and the user profile.

Following A on FIG. 5A to A on FIG. 5B, the method 500 determines 520 if the user has chosen auto selection of a wireless network 106. If the method 500 determines 520 that the user has not chosen auto selection of a wireless network 106, the method 500 presents 522 the identified wireless networks 106a-n along with rankings to the user. The method 500 receives 524 user input to select a wireless network (e.g. 106a), connects 526 the electronic device 104 to the selected wireless network 106a, and the method 500 ends. If the method 500 determines 520 that the user has chosen auto selection of a wireless network 106, the method 500 selects 528 the wireless network (e.g. 106b) with the highest ranking, connects 526 the electronic device 104 to the selected wireless network 106a, and the method 500 ends. In various embodiments, the method may use one or more of the identification module 202, the performance module 204, the rating module 206, the ranking module 208, the automatic selection module 302, the connection module 304, the presentation module 306, and the user selection module 308 in various steps of the method 500.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
identifying one or more wireless networks available for use by an electronic device;
determining performance characteristics of at least one of the one or more wireless networks;
determining a wireless network rating for at least one wireless network of the one or more wireless networks, wherein the wireless network rating comprises a rating obtained while the electronic device was previously connected to a network; and
ranking each of the wireless networks of the one or more wireless networks based on a user profile, the determined performance characteristics, and the wireless network rating for the wireless network.

2. The method of claim 1, wherein the wireless network rating comprises a rating available over the internet and wherein the electronic device downloads the wireless network rating while connected to the internet prior to identifying the one or more wireless networks.

3. The method of claim 2, wherein the wireless network rating comprises input from one or more users of the wireless network associated with the wireless network rating.

4. The method of claim 2, wherein the wireless network rating comprises a rating on a social media network.

5. The method of claim 1, wherein the wireless network rating is downloaded while the electronic device is connected to the wireless network associated with the wireless network rating at a time prior to identifying the one or more wireless networks.

6. The method of claim 1, further comprising:
selecting a wireless network of the one or more wireless networks with a highest ranking; and
connecting the electronic device to the selected wireless network.

7. The method of claim 1, further comprising:
presenting the one or more wireless networks to a user of the electronic device along with the ranking of each wireless network;
receiving from the user a selection of a wireless network of the one or more wireless networks; and
connecting the electronic device to the wireless network selected by the user.

8. The method of claim 1, wherein determining performance of at least one of the one or more wireless networks further comprises requesting performance information from at least one of the one or more wireless networks and receiving performance information from the one or more wireless networks where the performance information was requested.

9. The method of claim 8, wherein the performance information comprises one or more of firewall information, security information, current signal strength information, maximum signal strength information, wireless network speed, channel, and number of users.

10. The method of claim 1, wherein determining performance of at least one of the one or more wireless networks further comprises measuring bandwidth for a wireless network.

11. The method of claim 1, wherein the user profile comprises preferences for ranking available wireless networks.

12. The method of claim 11, wherein the user profile comprises one of a default user profile and a user modified user profile and wherein ranking of each of the wireless networks comprises using the default user profile if a modified user profile is unavailable.

13. A method comprising:
identifying one or more wireless networks available for use by an electronic device;
determining performance characteristics of at least one of the one or more wireless networks;
determining a wireless network rating for at least one wireless network of the one or more wireless networks, wherein the wireless network rating comprises a rating obtained while the electronic device was previously connected to a network, wherein the wireless network rating comprises a rating available over the internet and wherein the electronic device downloads the wireless network rating while connected to the internet prior to identifying the one or more wireless networks; and
ranking each of the wireless networks of the one or more wireless networks based on a user profile, the determined performance characteristics, and the wireless network rating for the wireless network;
presenting the one or more wireless networks to a user of the electronic device along with the ranking of each wireless network;
receiving from the user a selection of a wireless network of the one or more wireless networks; and
connecting the electronic device to the wireless network selected by the user.
